(19) United States
(12) Patent Application Publication
(10) Pub. No.: US 2025/0083977 A1
(43) Pub. Date: Mar. 13, 2025

(54) FLUID PROCESSING APPARATUS HAVING FLUID BRANCHING AND JOINING MEMBER

(71) Applicant: Stanley Electric Co., Ltd., Tokyo (JP)

(72) Inventors: Ryo SANO, Tokyo (JP); Hideaki TANAKA, Tokyo (JP); Hiroyuki KATO, Tokyo (JP)

(73) Assignee: Stanley Electric Co., Ltd., Tokyo (JP)

(21) Appl. No.: 18/823,846

(22) Filed: Sep. 4, 2024

(30) Foreign Application Priority Data
Sep. 11, 2023 (JP) 2023-146759

(51) Int. Cl. C02F 1/32

(52) U.S. Cl. CPC C02F 1/325; C02F 2201/3222; C02F 2201/3227; C02F 2201/328; C02F 2301/022

(57) ABSTRACT

A fluid processing apparatus includes: a casing partitioned by a fluid processing region, a fluid inlet region on an upstream side of the fluid processing region and having a fluid inlet, and a fluid outlet region on a downstream side of the fluid processing region and having a fluid outlet; a hollow fluid passage pipe provided in the fluid processing region of the casing; an ultraviolet ray emitting unit provided in the fluid outlet region of the casing; a fluid branching and joining member provided over the fluid inlet region and the fluid processing region of the casing and fixed by ribs to the casing.

### CROSS-REFERENCE TO RELATED APPLICATION

This application claims the priority benefit under 35 U.S.C. § 119 to Japanese Patent Application No. JP2023-146759 filed on Sep. 11, 2023, which disclosure is hereby incorporated in its entirety by reference.

### BACKGROUND

### Field

The presently disclosed subject matter relates to a fluid processing apparatus using ultraviolet rays.

### Description of the Related Art

Generally, a fluid processing apparatus using ultraviolet (UV) rays is used as a fluid sterilizer, a fluid disinfector, a fluid purifier and so on.

FIG. 10 is a longitudinal cross-sectional view illustrating a prior art fluid processing apparatus (see: JP2017-51290A).

In FIG. 10, the fluid processing apparatus is partitioned by a fluid processing region A, a fluid inlet region B on the upstream side of the fluid processing region A, and a fluid outlet region C on the downstream side of the fluid processing region A. Further, in more detail, the fluid processing apparatus is constructed by a hollow fluid passage pipe 101 provided in the fluid processing region A, a rectifying plate 102 at the upstream-side edge of the hollow fluid passage pipe 101 between the fluid inlet region B and the fluid processing region A and having multiple small circular openings 102a serving as rectifying mechanisms, and an ultraviolet (UV) ray emitting unit 103 including ultraviolet ray emitting elements such as ultraviolet ray (light) emitting (devices) (UV-LED) elements 103a, provided between the downstream-side edge of the hollow fluid pipe 101 and a fluid outlet OUT, for emitting ultraviolet rays, a rod lens 103b and an ultraviolet ray window 103c. Processed water W is taken into a casing (not shown) on the side of the fluid inlet IN, and then, is rectified by the rectifying plate 102, so that the processed eater W flows in a laminar flow state parallelly within the hollow fluid pipe 101. As a result, the processed water W is effectively irradiated with the ultraviolet rays UV in parallel with the axial direction of the hollow fluid passage pipe 101, thus enhancing the processing efficiency of the fluid processing apparatus. Then, the processed water W passes through the side of the ultraviolet ray emitting unit 103. Finally, the processed water W is discharged from the fluid outlet OUT. Note that the ultraviolet ray emitting unit 103 is formed by a water-proof structure to prevent water from infiltrating thereinto.

In the fluid processing apparatus of FIG. 10, however, ultraviolet rays UV are leaked from the small circular openings 102a and are further leaked from the junction of the casing (not shown) to the exterior. As a result, the leaked ultraviolet rays UV would affect human bodies, and also, the pipes coupled to the junction would deteriorate due to the leaked ultraviolet rays UV.

Also, in the fluid processing apparatus of FIG. 10, the diameter of each of the small circular openings 102a is small, i.e., about 2 mm so as to create laminar fluid streams in the fluid processing region A. Therefore, foreign matters whose areas are larger than about 3.14 mm² of the area of each of the small circular openings 102a would be clogged in the small circular openings 102a. Particularly, long and slender hair, flat scaling and the like would be clogged in the small circular openings 102a. As a result, the pressure loss of the apparatus would be increased. Also, the stream of the processed water W would be hindered by the clogged small circular openings 102a. Further, the clogged small circular openings 102a would be a hotbed for bacteria and so on.

Further, in the fluid processing apparatus of FIG. 10, since the flow rate of the processed water W along the wall of the hollow fluid passage pipe 101 is suppressed by the rectifying plate 102 as compared with the flow rate of the processed water W along the center axis of the hollow fluid passage pipe 101, the flow rate of the processed water W would be nonuniform within the hollow fluid passage pipe 101.

### SUMMARY

The presently disclosed subject matter seeks to solve one or more of the above-described problems.

According to the presently disclosed subject matter, a fluid processing apparatus includes: a casing partitioned by a fluid processing region, a fluid inlet region on an upstream side of the fluid processing region and having a fluid inlet, and a fluid outlet region on a downstream side of the fluid processing region and having a fluid outlet; a hollow fluid passage pipe provided in the fluid processing region of the casing; an ultraviolet ray emitting unit provided in the fluid outlet region of the casing; a fluid branching and joining member provided over the fluid inlet region and the fluid processing region of the casing and fixed by ribs to the casing. An inner diameter of the casing in the fluid processing region is larger than an inner diameter of the fluid inlet. The fluid branching and joining member includes: an ultraviolet ray absorbing and fluid branching member having a first cone-shaped structure with a first apex opposing the fluid inlet and a first vertical angle of the first apex; and an ultraviolet ray reflecting and fluid joining member having a second cone-shaped structure with a second apex opposing the fluid outlet and a second vertical angle of the second apex smaller than the first vertical angle. A bottom face of the ultraviolet ray absorbing and fluid branching member is fixed to a bottom face of the ultraviolet ray reflecting and fluid joining member.

According to the presently disclosed subject matter, since ultraviolet rays are reflected and absorbed by the fluid branching and joining member, and also, the ultraviolet rays are hardly leaked from the external periphery of the fluid branching and joining member, the leaked ultraviolet rays to the exterior would be decreased. Therefore, leaked ultraviolet rays would hardly affect human bodies, and also, pipes coupled to the junctions would not deteriorate.

Also, since the openings of the fluid branching and joining member adjacent to the ribs are radially longer and circumferentially wider, so that the openings can be larger than the prior art small circular openings, foreign matters whose areas are larger than 3.14 mm² would not be clogged in the radially-long and circumferentially-wide openings. Particularly, long and slender hair, flat scaling and the like would not be clogged in the radially-long and circumferentially-wide openings. As a result, the pressure loss of the apparatus would not be increased. Also, the stream of the processed water would not be hindered by the radially-long and circumferentially-wide openings. Further, there would be no hotbed for bacteria and so on.

Further, since the suppression of the flow rate of processed water along the wall of the hollow fluid passage pipe can be smaller than the suppression of the flow rate of the processed water at the center of the hollow fluid passage pipe, the maximum flow rate of the processed water can be small to uniform the flow rate distribution within the hollow fluid passage pipe, and also, the pressure loss can be decreased.

### BRIEF DESCRIPTION OF THE DRAWINGS

The above and other advantages and features of the presently disclosed subject matter will be more apparent from the following description of certain embodiments, as compared with the prior art, taken in conjunction with the accompanying drawings, wherein:

FIG. 1 is a longitudinal cross-sectional view illustrating an embodiment of the fluid processing apparatus according to the presently disclosed subject matter;

FIG. 2A is a longitudinal cross-sectional view for explaining UV ray reflection/transmission characteristics of the fluid branching and joining member of FIG. 1;

FIG. 2B is a diagram showing the simulated UV leakage of the fluid processing apparatus of FIG. 1;

FIG. 2C is a diagram showing the simulated UV leakage of the fluid processing apparatus of FIG. 10;

FIG. 3A is a partial longitudinal cross-sectional view for explaining the radially-long and circumferentially-wide openings of the fluid processing apparatus of FIG. 1;

FIG. 3B is a cross-sectional view taken along the line B-B of FIG. 3A;

FIG. 4A is a longitudinal cross-sectional view for explaining the flow rate of the fluid processing apparatus of FIG. 1;

FIG. 4B is a graph showing the total fluid passage cross section and the mean flow rate of the processed water in the fluid processing apparatus of FIG. 4A;

FIG. 5 is a diagram illustrating the fluid analysis (Fluent) result of the longitudinal fluid flow rate distributions and their enlarged distributions of the fluid processing apparatus of FIG. 1, where the UV ray reflecting and fluid joining member is plate-shaped, hemisphere-shaped and cone-shaped, respectively, when the mean flow rate of the processed water W in the fluid processing region A is 8 L/min;

FIG. 6 is a diagram illustrating the fluid analysis (Fluent) result of the longitudinal fluid flow rate distributions and their enlarged distributions of the fluid processing apparatus of FIG. 1, where the vertical angle β of the UV ray reflecting and fluid joining member is 80°, 90° and 60°, respectively, when the mean flow rate of the processed water W in the fluid processing region A is 8 L/min;

FIG. 7 is a diagram illustrating the fluid analysis (Fluent) result of the longitudinal fluid flow rate distributions and their enlarged distributions of the fluid processing apparatus of FIG. 1, where the inner edge face of the hollow fluid passage pipe is a flat face, a C30° face and a R30 mm face, respectively, when the mean flow rate of the processed water W in the fluid processing region A is 8 L/min;

FIG. 8 is a side view illustrating a first modification of the fluid branching and joining member of FIG. 1;

FIG. 9 is a side view illustrating a second modification of the fluid branching and joining member of FIG. 1; and

FIG. 10 is a longitudinal view illustrating a prior art fluid processing apparatus.

### DETAILED DESCRIPTION OF EXEMPLARY EMBODIMENTS

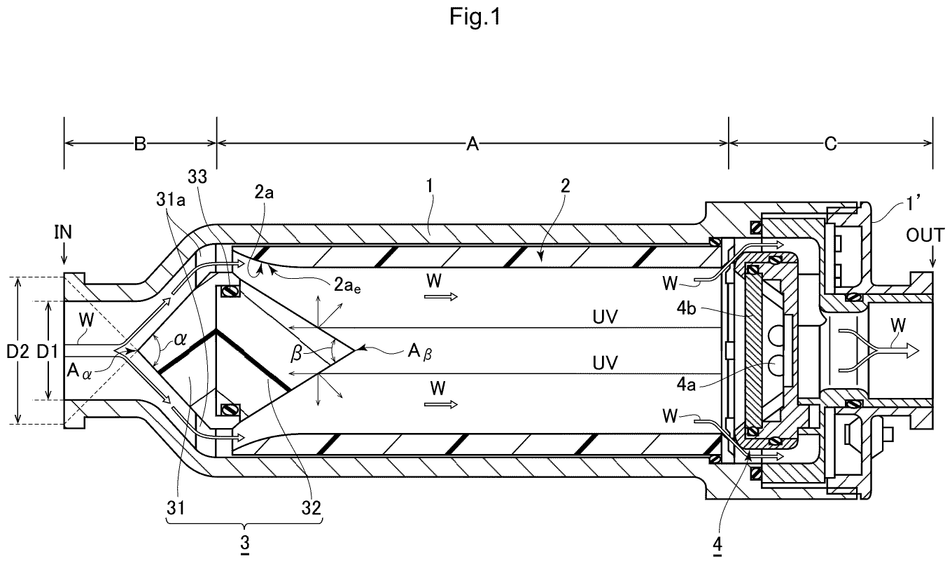

FIG. 1 is a longitudinal cross-sectional view illustrating an embodiment of the fluid processing apparatus according to the presently disclosed subject matter.

In FIG. 1, the fluid processing apparatus is partitioned by a fluid processing region A, a fluid inlet region B on the upstream side of the fluid processing region A, and a fluid outlet region C on the downstream side of the fluid processing region A. Further, in more detail, the fluid processing apparatus is constructed by a casing (or reactor) 1 provided over the fluid inlet region B, the fluid processing region A and the fluid outlet region C, a casing 1′ provided in the fluid outlet region C, a hollow fluid passage pipe 2 in the fluid processing region A, a fluid branching and joining member 3 serving as a rectifying mechanism within the casing 1 over the fluid processing region A, an ultraviolet emitting unit 4 within the casing 1 in the fluid outlet region C, a fluid inlet IN provided in an upstream-side edge of the casing 1 in the fluid inlet region B, and a fluid outlet OUT provided in a downstream-side edge of the casing 1′.

The casings 1 and 1′ are made of metal or ultraviolet ray absorbing resin such as polypropylene (PP) and serve as one casing in combination. The casings 1 and 1′ are separated from each other to incorporate the ultraviolet ray emitting unit 4 thereinto. The diameter of the casing 1 in the fluid inlet region B around the fluid inlet IN is so small as to enhance the mean flow rate of processed water W. Also, the diameter of the casing 1 in the fluid processing region A is made larger than the diameter of the casing 1 around the fluid inlet IN to decrease the mean flow rate of the processed water W. On the other hand, the diameter of the casing 1 in the fluid outlet region C on the side of the fluid processing region A is larger than the diameter of the casing 1 in the fluid processing region A, to thereby accommodate the ultraviolet ray emitting unit 4 in the fluid outlet region C.

The hollow fluid passage pipe 2 is made of ultraviolet ray reflecting material such as polytetra fluoroethylene (PTFE). The inner edge of the hollow fluid passage pipe 2 on the side of the fluid inlet IN is made curved-faced by a round (R) face 2a which is represented by R30 mm with a radius of 30 mm, for example. In other words, in case of R30 mm, R30 mm shows a curved-face by a part of a circumferential periphery having a radius of 30 mm in its cross section. The flow rate of processed water W is induced by the friction of the R face 2a so that the flow rate of the processed water W at the center axis of the fluid processing region A is suppressed. As a result, the fluid passage cross section S in the fluid processing region A is gradually increased, so that the mean flow rate of the processed water W within the fluid processing region A is gradually increased. Therefore, in the fluid processing region A on the downstream side of the R face 2a, the flow rate distribution of the processed water W can be uniform.

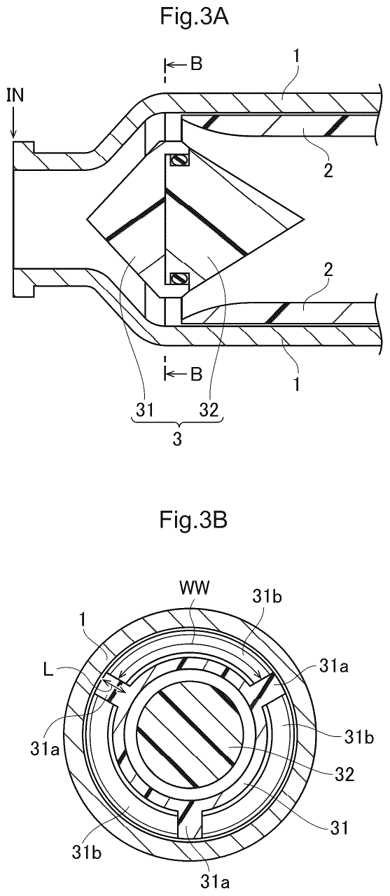

The fluid branching and joining member 3 is constructed by a cone-shaped ultraviolet ray absorbing and fluid branching member 31 having an apex Aa opposing the fluid inlet IN of the fluid inlet region B and a vertical angle α of the apex A_{α}, and a cone-shaped ultraviolet ray reflecting and fluid joining member 32 having an apex A_{β} opposing the fluid outlet OUT of the fluid outlet region C and a vertical angle β(<α) of the apex A_{β}. In this case, the bottom of the cone-shaped ultraviolet ray absorbing and fluid branching member 31 is coupled with a mirror adhesion to the bottom of the cone-shaped ultraviolet ray reflecting and fluid joining member 32 by an O-ring 33. Also, the inner diameter D1 of the fluid inlet IN is smaller than the inner diameter D2 formed at the fluid inlet IN by extensions of the envelope lines along the cone of the cone-shaped ultraviolet ray absorbing and fluid branching member 31, so that the processed water W will not collide vertically with the cone-shaped ultraviolet ray absorbing and fluid branching member 31, thus creating no convection. Further, the maximum outer diameter of the fluid branching and joining member 3 is larger than the inner diameter of the casing 1. The cone-shaped ultraviolet ray absorbing and fluid branching member 31 is made of ultraviolet ray reflecting material such as PP, and the cone-shaped ultraviolet ray reflecting and fluid joining member 32 is made of ultraviolet ray reflecting material such as PTFE. The fluid branching and joining member 3 is fixed by three ribs of the cone-shaped ultraviolet ray absorbing and fluid branching member 31 to the casing 1, so that three radially-long and circumferentially-wide openings 31b (see FIG. 3B) are formed between the ribs 31a. The ribs 31a are provided on the upstream-side cone-shaped ultraviolet ray absorbing and fluid branching member 31 preferably in view of sealing characteristics; however, the ribs 31a can be provided on the downstream-side cone-shaped ultraviolet ray reflecting and fluid joining member 32. The number of the ribs 31a is more than 2; however, since the more the number of the ribs 31a, the smaller the total cross section of the processed water W, it is best that the number of the ribs 31a is three. As a result, long and slender hair, flat scaling and foreign matters pass through the radially-long and circumferentially-wide openings 31b (see FIG. 3B). On the other hand, the processed water W taken in at the fluid inlet IN passes through the casing 1 within the fluid inlet region B, and then, passes through radially-long and circumferentially-wide openings 31b (see FIG. 3B) on the side of the fluid branching and joining member 3. Further, the processed water W passes through the casing 1 in the fluid processing region A and then, passes through the side of the ultraviolet ray emitting unit 4. Finally, the processed water W is discharged from the fluid outlet OUT. In this case, the mean flow rate of the processed water W is decreased by the cone-shaped ultraviolet ray absorbing and fluid branching member 31, and then, the mean flow rate of the processed water W is decreased by the radially-long and circumferentially-wide openings 31b between the ribs 31a. Finally, the mean flow rate of the processed water W is gradually decreased by the cone-shaped ultraviolet ray reflecting and fluid joining member 32, so that the flow rate of the processed water W is uniform, thus realizing a laminar flow state of the flow rate of the processed water W.

In FIG. 1, note that the terminal 2aₑ of the R face 2a is located on the upstream side of the apex A_{β} of the cone-shaped ultraviolet ray reflecting and fluid joining member 32; however, the terminal 2aₑ of the R face 2a can be located on the downstream side of the apex A_{β} of the cone-shaped ultraviolet ray reflecting and fluid joining member 32.

The ultraviolet ray emitting unit 4 has ultraviolet ray (light) emitting (devices) LED elements 4a and a ultraviolet ray window 4b, which could not be immersed into the processed water W due to the waterproof structure. The LED elements 4a emit ultraviolet rays UV having a wavelength of about 200 to 350 nm. Particularly, deep ultraviolet rays DUV with a short wavelength of about 210 to 300 nm can be used for disinfection, sterilization, purification and so on.

In FIG. 1, ultraviolet rays UV from the ultraviolet ray emitting unit 4 pass through the hollow fluid passage pipe 2 and then, are reflected by the cone-shaped ultraviolet ray reflecting and fluid joining member 32 to enhance the ultilization efficiency of ultraviolet rays UV, which can improve the disinfection efficiency or the like. In this case, the ultraviolet rays UV, which are not reflected by the cone-shaped ultraviolet ray reflecting and fluid joining member 32, are absorbed by the cone-shaped ultraviolet ray reflecting and fluid joining member 32 per se and the cone-shaped ultraviolet ray absorbing and fluid branching member 31, so that the ultraviolet rays UV can be attenuated. Also, since the maximum diameter of the fluid branching and joining member 3 is larger than the inner diameter of the casing 1 in the fluid inlet region B, the ultraviolet rays UV emitted from the ultraviolet ray emitting unit 4 through the fluid inlet IN to the exterior can be avoided.

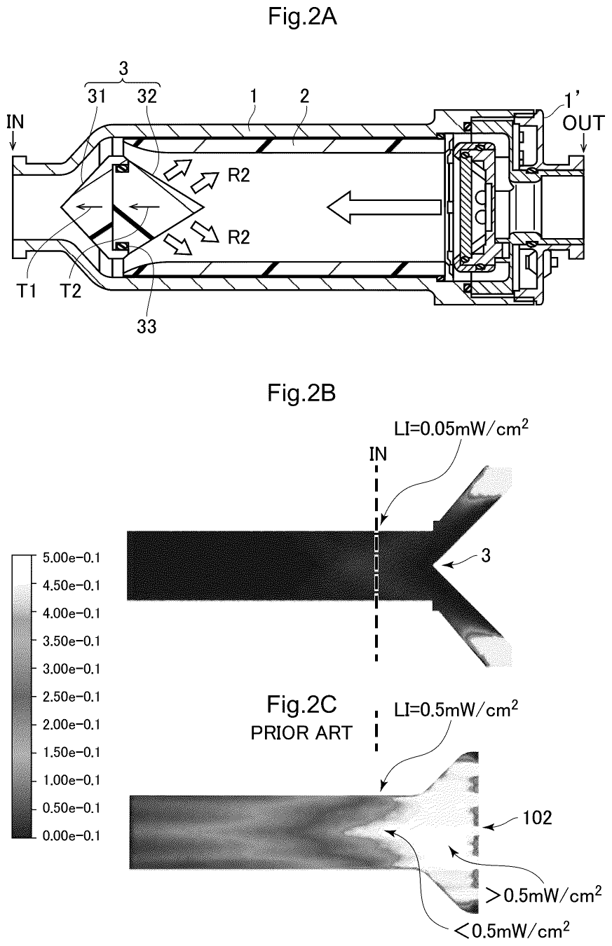

The leakage of ultraviolet rays UV in the fluid processing apparatus of FIG. 1 will be explained with reference to FIGS. 2A, 2B and 2C.

As illustrated in FIG. 2A, the ultraviolet rays UV are diffusively-reflected by the cone-shaped ultraviolet ray reflecting and fluid joining member 32, and then, the ultraviolet rays UV are absorbed by the cone-shaped ultraviolet ray absorbing and fluid branching member 31. For example, when the cone-shaped ultraviolet ray reflecting and fluid joining member 32 locating at the same axis of the casing 1 in the fluid inlet region B is made of 10 mm thick PTTE, the reflectivity R2 is about 99.84% and the transmission T2 is about 0.16%, so that most of the ultraviolet rays UV are reflected by the cone-shaped ultraviolet ray reflecting and fluid joining member 32. On the other hand, when the cone-shaped ultraviolet ray absorbing and fluid branching member 31 locating at the same axis of the casing 1 in the fluid inlet region B is made of 5 mm thick PP, and the transmission T1 is about 0.16%. As a result, the leakage of the ultraviolet rays UV from the fluid inlet IN through the fluid branching and joining member 3 are suppressed to be less than about 0.0003%. On the other hand, the ultraviolet rays UV passed through the radially-long and circumferentially-wide openings 31b are reflected from the inner face of the casing 1 in the fluid inlet IN toward the cone-shaped ultraviolet ray absorbing and fluid branching member 31, and then, are absorbed by the cone-shaped ultraviolet ray absorbing and fluid branching member 31.

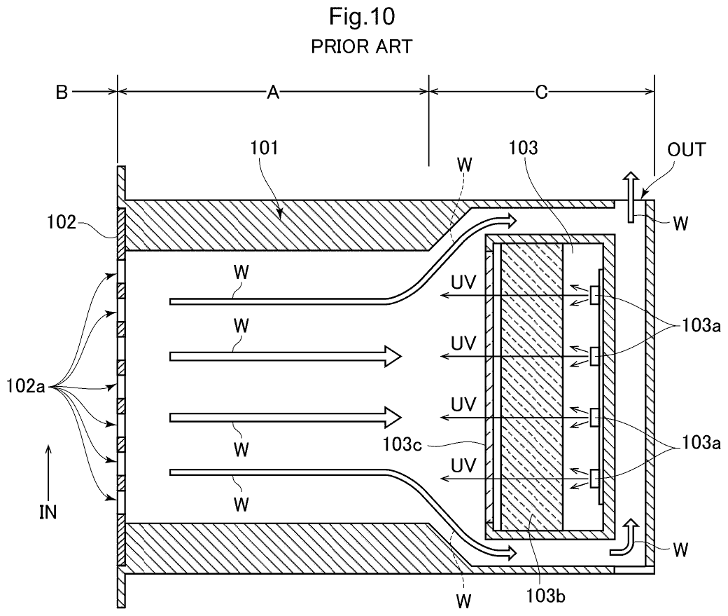

As illustrated in FIG. 2B, which shows the simulated optical analysis (ASAP) result of leakage of the ultraviolet rays UV at the fluid inlet IN of the fluid processing apparatus of FIG. 1, the leakage illumination LI at the fluid inlet IN was 0.05 mW/cm². On the other hand, as illustrated in FIG. 2C, which shows the simulated optical analysis (ASAP) result of leakage of the ultraviolet rays UV at the fluid inlet IN of the prior art fluid processing apparatus of FIG. 10, the leakage illumination LI at the fluid inlet IN was 0.5 mW/cm². That is, the leakage of the ultraviolet rays UV at the fluid inlet IN was decreased to about 1/20 as compared with the prior art fluid processing apparatus of FIG. 10, which exhibits a large improvement.

The radially-long and circumferentially-wide openings 31b of FIG. 1 are explained in detail with reference to FIGS. 3A and 3B. Here, FIG. 3A is a partial longitudinal view of the fluid processing apparatus of FIG. 1, and FIG. 3B is a cross-sectional view taken along the line B-B of FIG. 3A.

As illustrated in FIGS. 3A and 3B, the ultraviolet ray absorbing and fluid branching member 31 has the three equidistant ribs 31a which form the three radially-long and circumferentially-wide openings 31b with a radial length L and a circumferential width WW. For example, when the inner diameter of the casing 1 is 36 mm and the outer diameter of the cone-shaped ultraviolet ray absorbing and fluid branching member 31 is 26 mm, the radial length L and the circumferential width WW are 5 mm and 32 mm, respectively, the area of each of the radially-long and circumferentially-wide openings 31b is about 45 times as large as the openings 102a of FIG. 10 whose area is 3.14 mm². Therefore, foreign matters whose areas are about 142 mm², long and slender hair, flat scaling and the like can easily transmit through the radially-long and circumferentially-wide openings 31b. Therefore, the radially-long and circumferentially-wide openings 31b are hardly clogged. As a result, the pressure loss is so small that the processed water W is easy to flow therethrough, and there is no bed for bacteria and so on. Note that, when the radial length L of the radially-long and circumferentially-wide openings 31b is 5 mm, all the radially-long and circumferentially-wide openings 31b have the following total cross section:

$$142 {mm}^{2} \times 3 = 426 {mm}^{2}$$

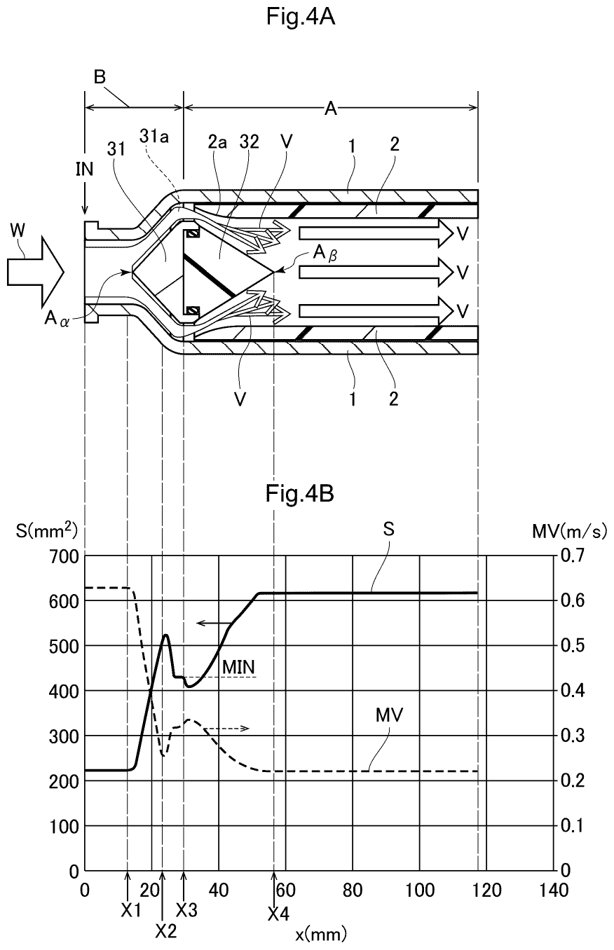

In this case, as illustrated in FIG. 4B, the minimum cross section MIN of the processed water W in the fluid processing region A is

MIN=426 mm²

Contrary to this, in the fluid processing apparatus of FIG. 10, the total cross section of the processed water W in the rectifying plate 102 is

$$3.14 {mm}^{2} \times 12 = 41 {mm}^{2}$$

and is much smaller than the minimum cross-section MIN of the processed water W in the radially-long and circumferentially-wide openings 31b.

The flow rate of the fluid processing apparatus of FIG. 1 is explained now with reference to FIGS. 4A and 4B. Here, FIG. 4A is a part longitudinal cross-sectional view illustrating the flow rate V of the processed water W, and FIG. 4B is a graph showing the total cross section S and the mean flow rate MV of the processed water W.

The total cross section S and the mean flow rate MV have the following relationship:

$$S \cdot MV = Q$$

where Q is the flow amount of the processed water W which is a definite value such as 8 L/min.

First, from x=0 at the fluid inlet IN to x=x1 at the apex Aa of the ultraviolet ray absorbing and fluid branching member 31, the total cross section S of the processed water W is definite, i.e., about 220 mm². As a result, the mean flow rate MV is also definite, i.e., about 0.61 m/s.

Next, from x=x1 to x=x2 where the ribs 31a are located, the processed water W contacts the cone-shaped ultraviolet ray absorbing and fluid branching member 31, so that the total cross section S of the processed water W rapidly increases. As a result, the mean flow rate MV of the processed water W rapidly decreases.

Next, from x=x2 to x=x3 where the upstream-side location of the cone-shaped ultraviolet ray reflecting and fluid joining member 32 is located, due to the presence of the ribs 31a, the total cross section S of the processed water W rapidly decreases. As a result, the mean flow rate MV of the processed water W rapidly increases.

Next, from x=x3 to x=x4 where the apex A_{β} of the cone-shaped ultraviolet ray reflecting and fluid joining member 32 is located, the total cross section S of the processed water W gradually increases from about 410 mm² to about 620 mm². As a result, the mean flow rate MV of the processed water W gradually decreases to about 0.32 m/s. Note that the curved-face of the R-face 2a contributes to this gradual increase of the total cross section S, i.e., the gradual decrease of the mean flow rate MV.

Finally, the total cross section S of the processed water W is definite, i.e., about 620 mm². As a result, the mean flow rate MV is also definite, i.e., about 0.22 m/s.

Thus, according to FIGS. 4A and 4B, the mean flow rate MV is rapidly decreased by the cone-shaped ultraviolet ray absorbing and fluid branching member 31, and then, the mean flow rate MV is gradually decreased by the cone-shaped ultraviolet ray reflecting and fluid joining member 32. Finally, from x=x4, the mean flow rate MV is definite, so as to enhance the processing efficiency.

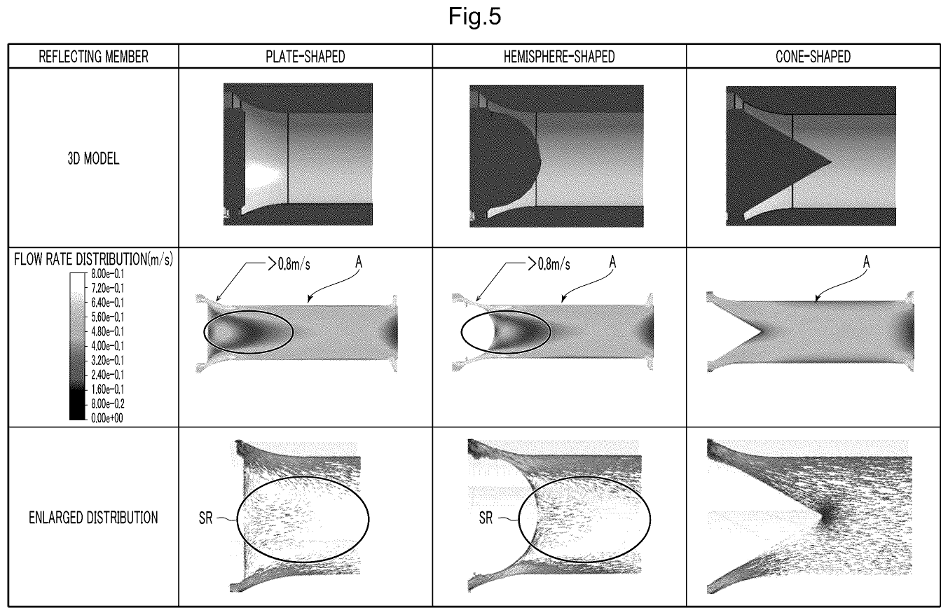

The rectifying effect of the fluid processing apparatus of FIG. 1 is explained now with reference to FIG. 5, where the ultraviolet ray reflecting and fluid joining apparatus of FIG. 1 is assumed to have a plate-shaped structure, a hemisphere-shaped structure and a cone-shaped structure, respectively, to obtain the fluid analysis (Fluent) result under the condition that the flow rate of the processed water W is 8 L/min.

As illustrated in FIG. 5, if the ultraviolet ray reflecting and fluid joining member is plate-shaped or hemisphere-shaped, the total cross section S of the processed water W is rapidly increased, so that a stagnated region SR where the flow rate V is 0 is generated. Contrary to this, when the ultraviolet ray reflecting and fluid joining member is cone-shaped according to the presently disclosed subject matter, the total cross section S of the processed water W is gradually increased due to the cone-shaped structure, so that no stagnated region SR could be generated.

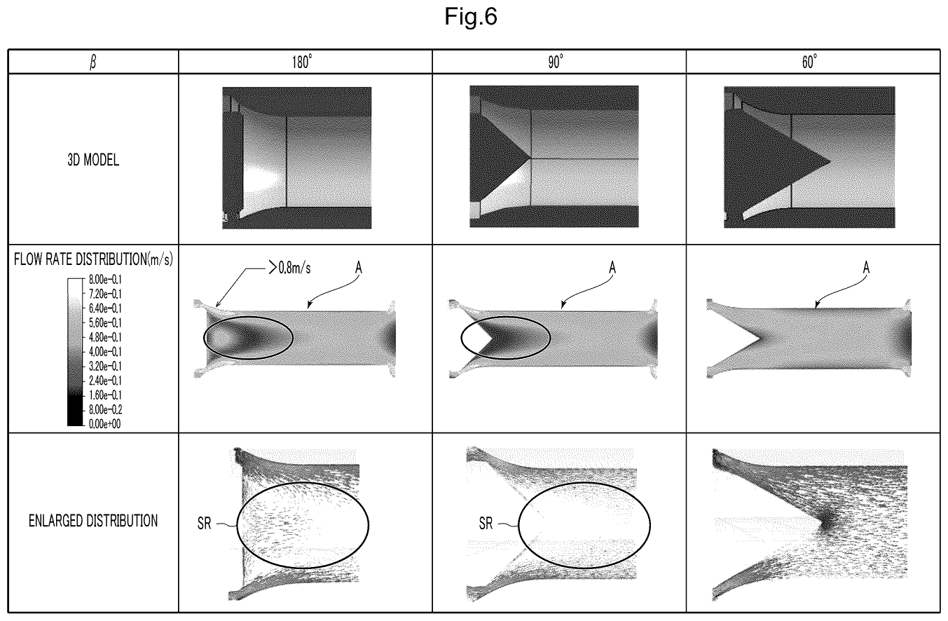

The rectifying effect of the fluid processing apparatus of FIG. 1 is explained now with reference to FIG. 6, where the ultraviolet ray reflecting and fluid joining apparatus of FIG. 1 is assumed to have an apex β whose value is 180°, 90° and 60°, respectively, to obtain the fluid analysis (Fluent) result under the condition that the flow rate of the processed water W is 8 L/min.

As illustrated in FIG. 6, if the apex β of the ultraviolet ray reflecting and fluid joining member is 180° or 90°, the total cross section S of the processed water W is rapidly increased, so that a stagnated region SR where the flow rate V is 0 is generated. Contrary to this, when the apex β of the ultraviolet ray reflecting and fluid joining member is 60° according to the presently disclosed subject matter, the total cross section S of the processed water W is gradually increased due to the apex β(=60°), so that no stagnated region SR could be generated. In this case, the apex β is preferably 45° to 80° in consideration of the rectifying effect and the mean flow rate MV; however, 60° is best for the apex β.

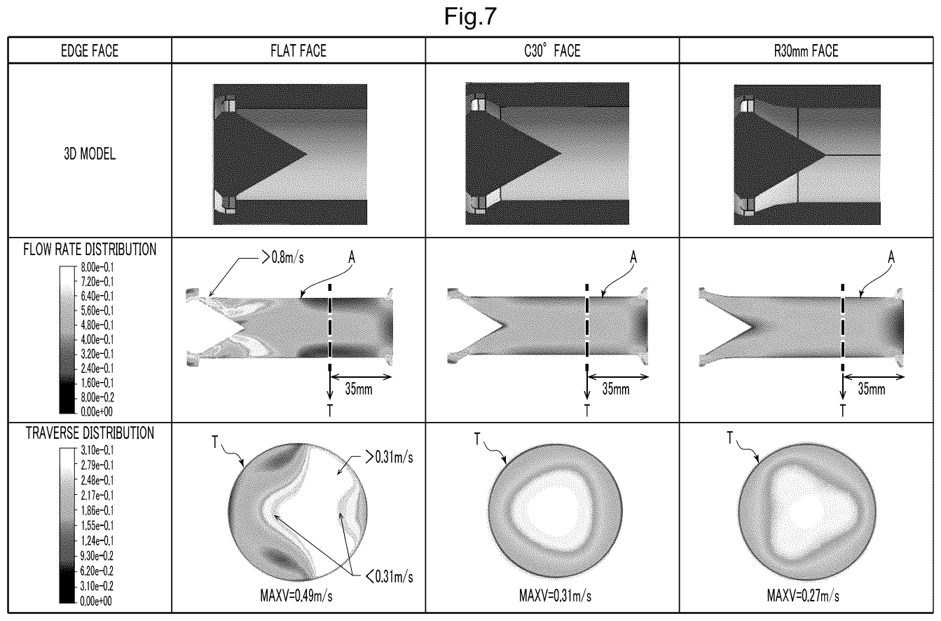

The rectifying effect of the fluid processing apparatus of FIG. 1 is explained now with reference to FIG. 7, where the inner edge face of the hollow fluid passage pipe of FIG. 1 is assumed to have a flat face, a cut(C) 30° face and a R 30 mm face, respectively, to obtain the fluid analysis (Fluent) result under the condition that the flow rate of the processed water W is 8 L/min.

As illustrated in FIG. 7, if the inner edge face of the hollow fluid passage pipe 2 is a flat face, the fluid inlet side edge of the hollow fluid passage pipe 2 is resistant to the processed water W so as not to uniform the flow rate of the processed water W. As a result, the maximum flow rate MAXV at the traverse cross-section T within the fluid processing region A was 0.49 m/s. Also, if the inner edge face of the hollow fluid passage pipe 2 is a C30°-face, the fluid inlet side edge of the hollow fluid passage pipe 2 is less resistant to the processed water W than the flat-face inner edge face. However, the processed water W would collide with the C30° face, the flow rate of the processed water W would still fluctuate. As a result, the maximum flow rate MAXV at the traverse cross-section T within the fluid processing region A was 0.31 m/s. Contrary to this, when the inner edge face of the hollow fluid passage pipe 2 is an R30 mm face, the total cross section of the processed water is gradually increased, so that the flow rate V along the sidewall of the hollow fluid passage pipe 2 is suppressed by the frictional force of the hollow fluid passage pipe 2 as compared with the flow rate at the center of the hollow fluid passage pipe 2. As a result, the flow rate within the fluid processing region A becomes uniform so that the maximum flow rate MAXV at the traverse cross-section T was 0.27 m/s. Thus, the processing efficiency can be enhanced.

Instead of polypropylene (PP), the cone-shaped ultraviolet ray absorbing and fluid branching member 31 can be made of resin such as polyphenylene sulfide (PPS) and other ultraviolet absorbing members such as chromium, black alumina and carbon black. Also, weathering resistant additives, glass fillers, titanium oxide or zinc oxide can be added to prevent the resin from deteriorating. Further, non-ultraviolet transmissive material such as SUS and anodized aluminum can be used.

Instead of polytetrafluoroethylene (PTFE), the cone-shaped ultraviolet ray reflecting and fluid joining member 32 can be made of fluororesin such as tetrafluoroethylene-perfluoroalkylvinylether (PFA) copolymer, tetrafluoroethylene hexafluoropropylene (FEP) copolymer, polychlorotrifluoroethylene (PCTFE) or polyvinylidenefluoride (PVDF).

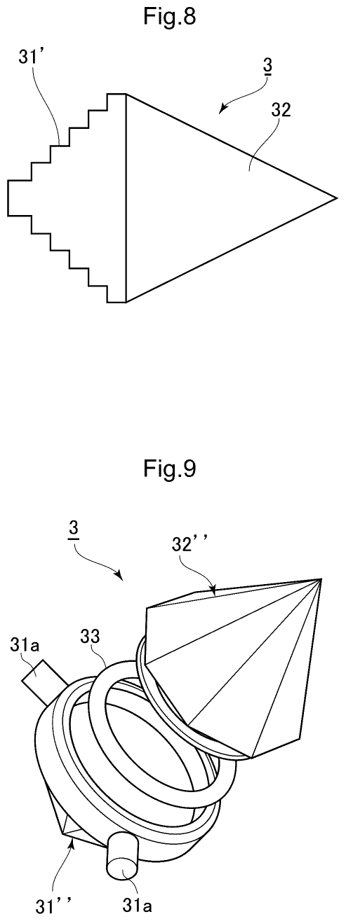

In the above-described embodiment, the cone-shaped ultraviolet ray absorbing and fluid branching member 31 is linearly-changed cone-shaped; however, a cone-shaped ultraviolet ray absorbing and fluid branching member 31′ stepwisely-changed cone-shaped as illustrated in FIG. 8 can be used. In this case, since the contact area between the processed water W and the cone-shaped ultraviolet ray absorbing and fluid branching member 31′ can be increased to increase the reduction of the flow rate of the processed water W, which improves the rectifying effect. Note that the cone-shaped ultraviolet ray reflecting and fluid joining member 32 should not be stepwisely cone-shaped in consideration of the nonuniform flow rate. Thus, the cone-shaped ultraviolet ray absorbing and fluid branching member 31 and the cone-shaped ultraviolet ray reflecting and fluid joining member 32 may be simply cone-shaped.

Further, the cone-shaped ultraviolet ray absorbing and fluid branching member 31 can be made of the same ultraviolet ray reflecting material of the cone-shaped ultraviolet ray reflecting and fluid joining member 32. Of course, the leakage amount of ultraviolet rays would be increased, which would create no problem. In this case, when the cone-shaped ultraviolet ray absorbing and fluid branching member 31 and the cone-shaped ultraviolet ray reflecting and fluid joining member 32 are made of a single material, the manufacturing lost can be decreased.

Still further, as illustrated in FIG. 9, the cone-shaped ultraviolet ray absorbing and fluid branching member 31 can be formed by a polyangular pyramid member 31″ such as a first triangular pyramid shaped member with a first bottom face, and the cone-shaped ultraviolet ray reflecting and fluid joining member 32 can be formed by a second polyangular pyramid member 32″ with a second bottom face coupled by the O-ring 33 to the first bottom face.

The fluid processing apparatus can be applied to a water storage tank such as an ice manufacturing machine, a water pipe, a hot-water supply machine, a water server, a coolant water circulator, a water cooler, a drink server, a medical pure water manufacturing unit, a dental chair and a tableware washer.

It will be apparent to those skilled in the art that various modifications and variations can be made in the presently disclosed subject matter without departing from the spirit or scope of the presently disclosed subject matter. Thus, it is intended that the presently disclosed subject matter covers the modifications and variations of the presently disclosed subject matter provided they come within the scope of the appended claims and their equivalents. All related or prior art references described above and in the Background section of the present specification are hereby incorporated in their entirety by reference.

1. A fluid processing apparatus comprising:
a casing partitioned by a fluid processing region, a fluid inlet region on an upstream side of said fluid processing region and having a fluid inlet, and a fluid outlet region on a downstream side of said fluid processing region and having a fluid outlet;
a hollow fluid passage pipe provided in said fluid processing region of said casing;
an ultraviolet ray emitting unit provided in said fluid outlet region of said casing; and
a fluid branching and joining member provided over said fluid inlet region and said fluid processing region of said casing and fixed by ribs to said casing,
an inner diameter of said casing in said fluid processing region being larger than an inner diameter of said fluid inlet,
said fluid branching and joining member comprising:
an ultraviolet ray absorbing and fluid branching member having a first cone-shaped structure with a first apex opposing said fluid inlet and a first vertical angle of said first apex; and
an ultraviolet ray reflecting and fluid joining member having a second cone-shaped structure with a second apex opposing said fluid outlet and a second vertical angle of said second apex smaller than said first vertical angle,
a bottom face of said ultraviolet ray absorbing and fluid branching member being fixed to a bottom face of said ultraviolet ray reflecting and fluid joining member.

2. The fluid processing apparatus as set forth in claim 1, wherein said second apex is from 45° to 80°.

3. The fluid processing apparatus as set forth in claim 1, wherein an inner edge face on a fluid inlet side of said hollow fluid passage pipe forms a curved-face, so that a fluid passage cross section is gradually decreased from the inner edge face on the fluid inlet side to said ultraviolet ray reflecting and fluid joining member.

4. The fluid processing apparatus as set forth in claim 1, wherein an inner diameter of said fluid inlet is smaller than an inner diameter formed at said fluid inlet formed by extensions of envelope lines of said first cone structure.

5. The fluid processing apparatus as set forth in claim 1, where said first cone-shaped structure comprises a stepwise cone-shaped structure.

6. The fluid processing apparatus as set forth in claim 1, where said first cone-shaped structure comprises a circular or polygonal cone-shaped structure.

7. The fluid processing apparatus as set forth in claim 1, where said second cone-shaped structure comprises a circular or polygonal cone-shaped structure.

8. The fluid processing apparatus as set forth in claim 1, wherein said ultraviolet ray absorbing and fluid branching member and said ultraviolet ray reflecting and fluid joining member comprise a same ultraviolet ray reflecting material.

9. The fluid processing apparatus as set forth in claim 8, wherein said ultraviolet ray absorbing and fluid branching member and said ultraviolet ray reflecting and fluid joining member comprise a single ultraviolet ray reflecting material.

10. The fluid processing apparatus as set forth in claim 1, wherein said ribs are mounted on said ultraviolet ray absorbing and fluid branching member.

11. The fluid processing apparatus as set forth in claim 1, further comprising an O-ring inserted between said ultraviolet ray absorbing and fluid branching member and said ultraviolet ray reflecting and fluid joining member.

12. The fluid processing apparatus as set forth in claim 1, wherein said hollow fluid passage pipe comprises an ultraviolet ray reflecting material.

13. The fluid processing apparatus as set forth in claim 1, wherein said casing comprise a first casing provided over said fluid inlet region, said fluid processing region and said fluid outlet region and a second casing provided over said fluid outlet region, said first and second casings being separated from each other to incorporate said ultraviolet ray emitting unit.

14. The fluid processing apparatus as set forth in claim 13, wherein a diameter of said first casing in said fluid outlet region on a side of said fluid processing region is larger than a diameter of said first casing in said fluid processing region, to accommodate said ultraviolet ray emitting unit into said fluid outlet region.

15. The fluid processing apparatus as set forth in claim 1, wherein a maximum outer diameter of said fluid branching and joining member is larger than an inner diameter of said casing in said fluid inlet region.

16. The fluid processing apparatus as set forth in claim 1, wherein said ultraviolet ray absorbing and fluid branching member comprises a first polyangular pyramid member with a first bottom face, and said ultraviolet ray reflecting and fluid joining member comprises a second polyangular pyramid member with a second bottom face coupled to said first bottom face.
